(19) United States
(12) Patent Application Publication
(10) Pub. No.: US 2024/0253131 A1
(43) Pub. Date: Aug. 1, 2024

(54) Door Lock Installation Jig

(71) Applicant: Joseph Schramek, Dekalb, IL (US)

(72) Inventor: Joseph Schramek, Dekalb, IL (US)

(73) Assignee: Nomis LLC, Elgin, IL (US)

(21) Appl. No.: 18/413,875

(22) Filed: Jan. 16, 2024

Related U.S. Application Data
(60) Provisional application No. 63/481,949, filed on Jan. 27, 2023.

(51) Int. Cl. B23B 47/28

(52) U.S. Cl. CPC B23B 47/287

(57) ABSTRACT

A backset jig is provided for guiding a hole saw. The jig includes a frame with a first leg positionable adjacent to a first side of a door panel, and a second leg positionable adjacent to a second side of the door panel. The first and second legs are operably coupled with each other by an intermediate portion designed to abut an edge of the door panel. The first leg includes a guide insert for forming a doorhandle borehole, and the intermediate portion includes a guide for forming a latch borehole. The guide insert includes a hole saw guide aperture with a hole saw teeth clearance region and a hole saw guide region, the latter of which has a smaller diameter than the former.

### CROSS-REFERENCE TO RELATED PATENT APPLICATIONS

This patent application claims the benefit of U.S. Provisional Patent Application No. 63/481,949, filed Jan. 27, 2023, the entire teachings and disclosure of which are incorporated herein by reference thereto.

### FIELD OF THE INVENTION

This invention generally relates to providing alignment to boreholes into a door, and more particularly to a backset jig.

### BACKGROUND OF THE INVENTION

Door lock assemblies typically comprise doorhandles and locksets that interact with the door and are used to secure the door in a closed and locked arrangement relative to a door opening (e.g. door jamb or casing). In this regard, a borehole is provided through the door to accommodate the doorhandle's passage from the inside to the outside of the door. Typically, the doorhandle is positioned proximate to the opposite side of the door from a hinge assembly and at waist height for an average person. A second borehole, known as the latch borehole, is provided in an edge of the door that extends between opposed sides of the door. The latch borehole is typically perpendicular to the doorhandle borehole to accommodate the latch of the door lock assembly.

The latch borehole must interact with the doorhandle borehole and sized depending on the size and configuration of the lockset to be installed therein. To ensure this interaction, the doorhandle borehole must be appropriately spaced from an edge of the door. This spacing is known as the “backset.”

To provide this spacing and alignment, a backset jig may be used. The jig is attached to the door and typically in abutment with the edge of the door and provides the precise locations for drilling the doorhandle and latch boreholes with a hole saw of corresponding sizes.

However, in many instances, different jigs may be required to accommodate the different backset options of 2⅜ inches or 2¾ inches. The jigs will include guides for guiding the corresponding hole saw as it rotates to cut the corresponding boreholes. Furthermore, when the hole saw rotates within the jigs to form the boreholes, it the teeth of the hole saw can engage the holes forming the guides and frequently damages the jigs.

The present invention provides a door lock installation jig that improves on existing jig designs to eliminate these and other issues. These and other advantages of the invention, as well as additional inventive features, will be apparent from the description of the invention provided herein.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective illustration of a door lock backset jig mounted to a door panel;

FIG. 2 is an exploded illustration of the jig of FIG. 1;

FIG. 3 is a rear perspective illustration of the jig of FIG. 1 removed from the door panel;

FIGS. 4 and 5 are top view illustrations of the jig of FIG. 1 configured to mount to two different thickness door panels.

FIG. 6 is a perspective illustration of the jig of FIG. 1 in a first configuration for forming the latch borehole at a first backset distance;

FIG. 7 is a side view illustration of the jig as configured in FIG. 6;

FIG. 8 is a perspective illustration of the jig of FIG. 1 in a second configuration for forming the latch borehole at a second backset distance;

FIG. 9 is a side view illustration of the jig as configured in FIG. 8;

FIG. 10 is a perspective illustration of a hole saw guide insert removed from the frame of the jig of FIG. 1;

FIG. 11 is an elevation view of the hole saw guide insert of FIG. 10;

FIG. 12 is an exploded illustration of the hole saw guide insert of FIG. 11;

FIG. 13 is a perspective illustration of the frame of the jig of FIG. 1 with the hole saw guide insert removed therefrom;

FIG. 14 is an elevation view of a leg of the frame of FIG. 13;

FIG. 15 is a cross-sectional illustration of the jig of FIG. 1 attached to a door panel having a first thickness prior to beginning drilling of the latch bore hole with the hole saw fully inserted into the guide insert;

FIG. 16 is a cross-sectional illustration of the jig of FIG. 1 attached to a door panel having a second thickness being less than the thickness in FIG. 15 prior to beginning drilling of the latch bore hole with the hole saw fully inserted into the guide insert;

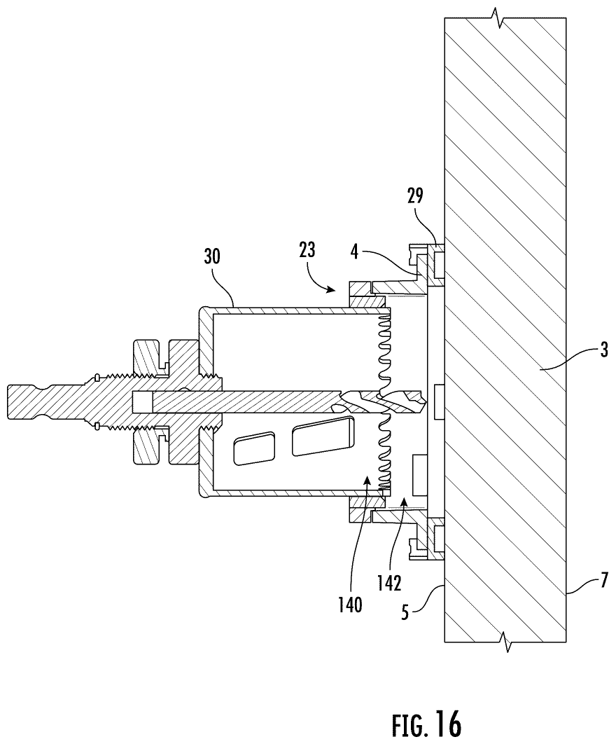

FIGS. 17 and 18 are perspective illustrations of a second embodiment of a backset jig;

FIG. 19A is a cross-sectional illustration of a hole saw used with the jigs herein; and

FIG. 19B is a cross-sectional illustration of the hole saw inserted into a jig of FIG. 1 showing the relationship of the teeth and guide bit of the hole saw relative to a teeth clearance region of the guide insert of the jig.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

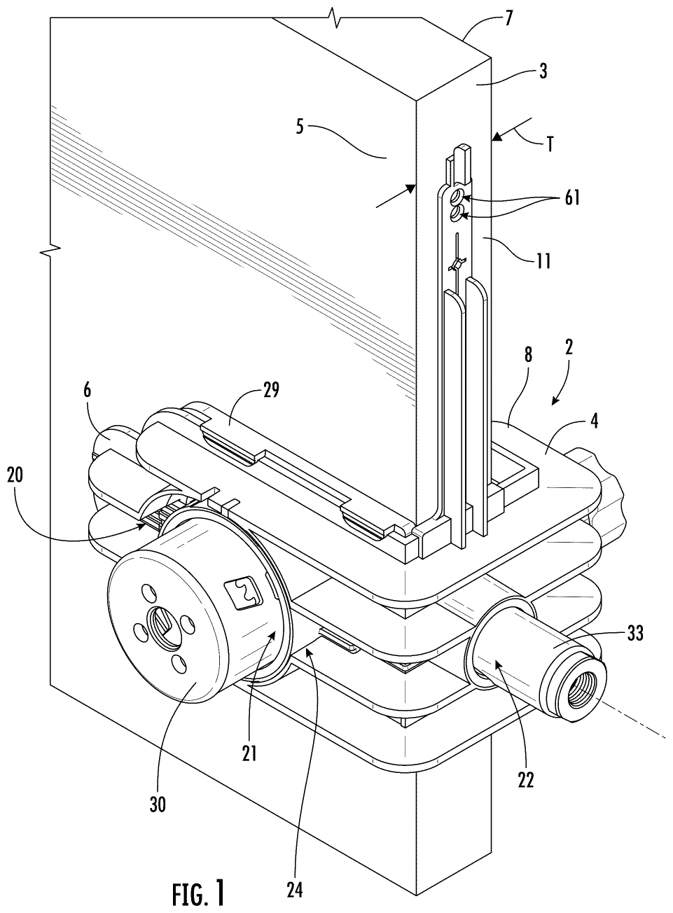

FIG. 1 illustrates a door lock backset jig 2 according to an example of the application mounted to a door panel 3.

The jig 2 includes a frame 4 that straddles the door panel 3. The jig 2 has a first leg 6 positioned adjacent to a first side 5 of the door panel 3 and a second leg 8 positioned adjacent to a second side 7 of the door panel 3. The first and second legs 6, 8 are operably coupled with each other by an intermediate portion 10. The intermediate portion 10 operably abuts an edge 11 of the door panel 3, which extends between the opposed first and second sides 5, 7.

In this example, the frame 4 forms an overall J-shape, with one leg (the second leg 8) shorter than the other (first leg 6).

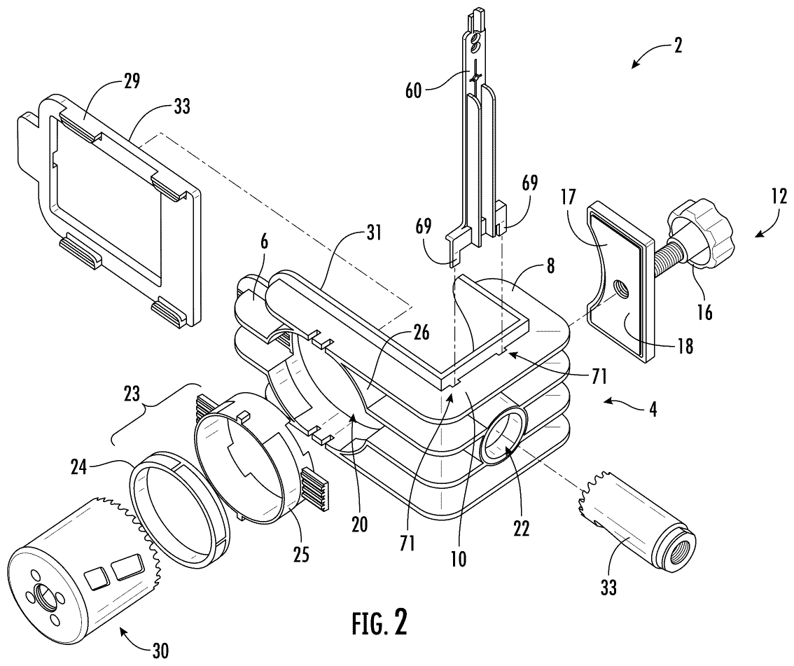

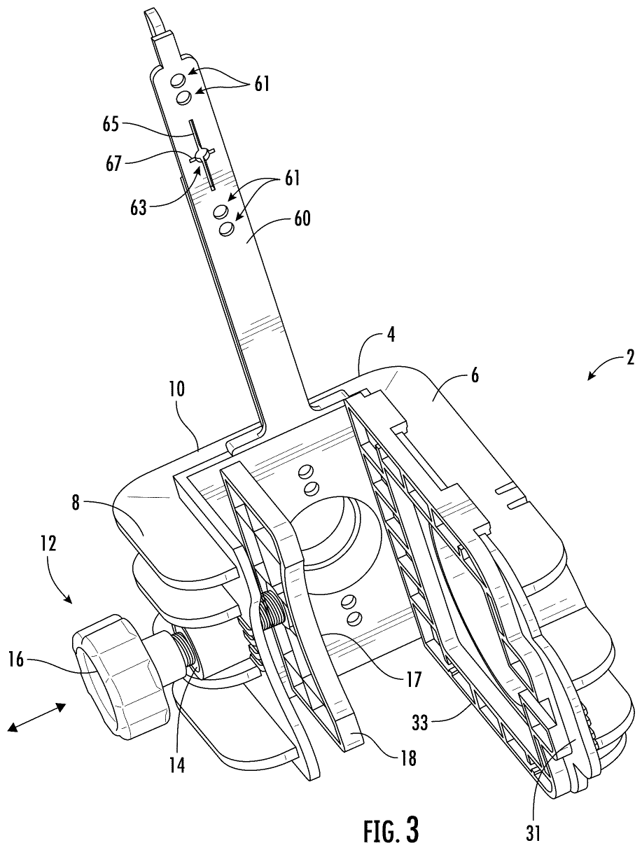

The body of the frame 4 may be molded from a plastic material. In one example, the first leg 6, second leg 8, and intermediate portion 10 are all formed from a single continuous piece of material. However, in other examples, the body of the frame 4 could be formed from multiple components interconnected components. With additional reference to FIGS. 2 and 3, the jig 2 includes a clamp 12 mounted to the second leg 8 of the frame 4 that enables the jig 2 to be attached to the door panel 3, such as by clamping. The second leg 8 includes a through aperture (not shown), which carries a threaded nut 14. The threaded nut 14 threadedly receives a threaded thumb screw 16 of the clamp 12.

The clamp 12 of jig 2 also includes a clamp body 18 secured to the threaded thumb screw 16 that moves toward or away from the second leg 8 as the threaded thumb screw 16 of the clamp 12 is rotated relative to threaded nut 14 to adjust a spacing between clamping surface 17 relative to first leg 6. This allows for a clamping force to be generated as well as to accommodate different width doors panels 3.

The intermediate portion 10 includes a latch bore aperture 22 for guiding a second hole saw 33 for forming the latch borehole. The present embodiment may be adjustable to enable the jig 2 to be used with doors that have different thicknesses.

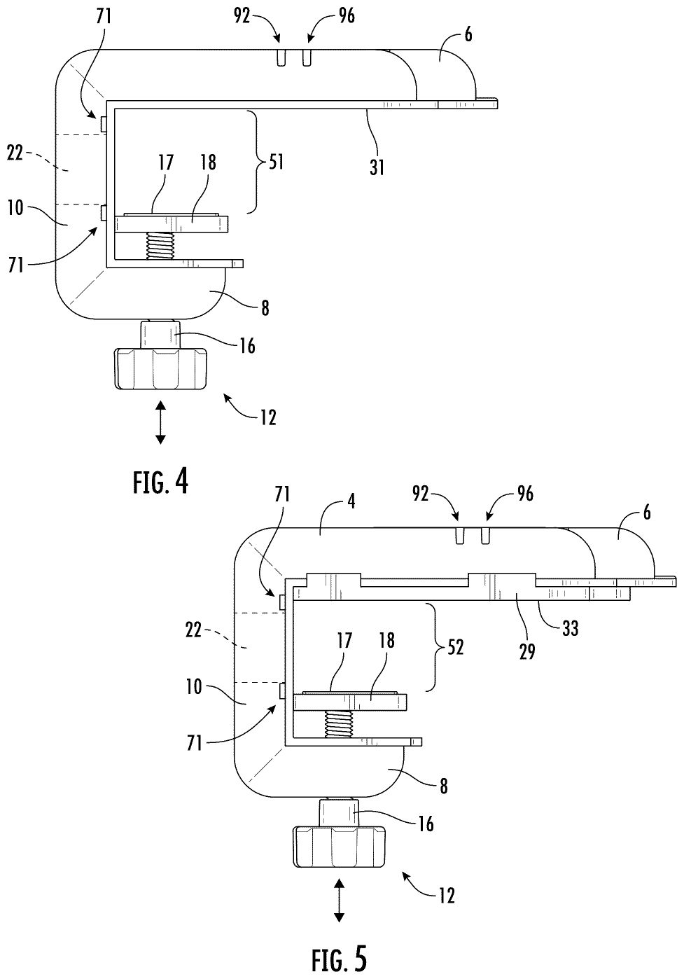

With reference to FIGS. 1, 4 and 5, to accommodate different door thicknesses, a spacer 29 may be attached to the first leg 6. In this example, the spacer 29 extends along the length of the first leg 6, to provide an abutment surface 54 and compensate for reduced door thicknesses. With the spacer 29 removed as in FIG. 4, the jig 2 accommodates thicker door panels. In particular, inner surface 31 of first leg 6 will abut against a first side 5 of the door panel 3 while the clamp body 18 of clamp 12 will abut against the opposed second side 7 of the door panel 3. As illustrated in FIG. 4, the clamp body 18 will have a first spacing S1 between surface 31 and clamp body 18 to accommodate the particular door width.

However, to accommodate thinner door panels while still keeping aperture 22 centered on the door panel so as to form the latch borehole in the center of edge 11 of the door panel 3, the spacer 29 can be attached to first leg 6. Here, the abutment surface 33 of the spacer 29 will abut first side 5 of the door panel while once again the clamp body 18 will abut the other second side 7. Here, the spacer 29 will compensate for half of the reduced thickness from the wider door panel. Here, the clamp body 18 will have a second spacing S2 relative to surface 33 that is smaller than spacing S1.

For example, the jig 2 could be configured to work with a first door panel width of 2.5 inches when the spacer 29 is removed and a door panel width of 2 inches when the spacer is installed. Thus, spacing S1 would be approximately 2.5 inches when the jig 2 is installed.

To accommodate for the thinner 2 inch door panel 3, the spacer 29 would typically offset the first leg 6 one-quarter inch from the first side 5 of the thinner door panel 3. The other one-quarter inch of reduction in door panel width would be compensated for by the clamp 12. In particular, the clamp body 18 would be actuated further inward by threaded thumb screw 12 for the narrower door panel 3. As such, the spacing S2 between the clamp body 18 and surface 33 would be approximately 2 inches when the jig 2 is installed on the thinner door panel.

With reference to FIGS. 1-3, the present embodiment also includes a lock locator 60 for locating the position of a deadbolt lock relative to the lockset. The lock locator 60 is attached to the intermediate portion 10 and positioned against the edge 11 of the door panel 3. The lock locator 60 includes four holes 61 for drilling holes in the edge 11 of the door. A lock center finder aperture 63 can be used to locate a hole for insertion of the deadbolt latch. The lock center finder aperture 63 includes first slot 65 and second slot 67 that is perpendicular to the first slot 65. These slots can be used to draw centering lines on the edge of the door where a deadbolt latch borehole may be formed. In some implementations, a user may drill a hole through the center of lock center finder aperture 63 into the edge 11 of the door panel.

In this example, the lock locator 60 is removably attached to the frame 4. With reference to FIG. 2, the lock locator 60 includes a pair of axially extending tabs 69 that are axially inserted into slots 71 in the intermediate portion 10 of frame 4. The engagement between the intermediate portion 10 and the tabs 69 may have a friction fit or snap fit engagement to secure the two components to one another. Other securement structure, such as a screws/bolts, may be provided.

With principle reference to FIGS. 2 and 6-9, the jig 2 is configured to form door handle boreholes at different back sets from the edge 11 of the door panel 3. This accommodates different lockset configurations.

In particular, the jig 2 includes door latch hole saw guide insert 23 that is removably attachable to first leg 6 at different positions to accommodate the different backsets. The guide insert 23 guides a first hole saw 30 (see FIG. 2) for forming the door handle borehole in the door panel 3. In particular, the guide insert 23 defines a guide aperture 21 that receives the first hole saw 30 in operation.

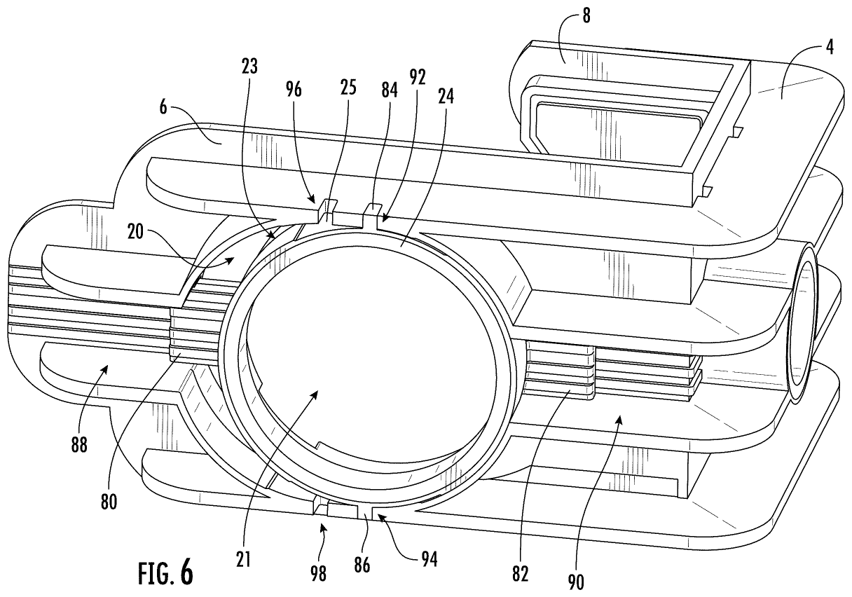

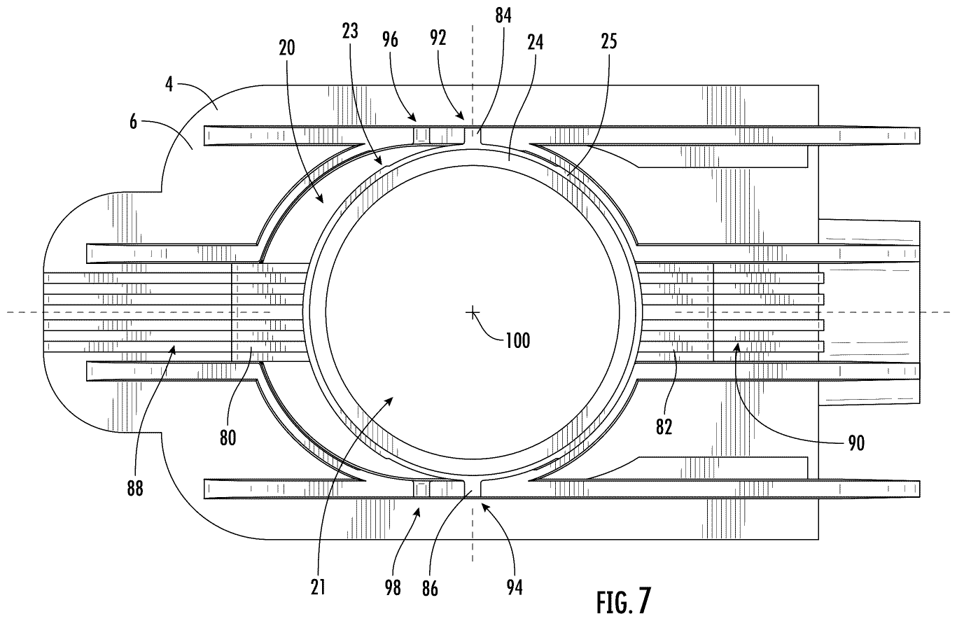

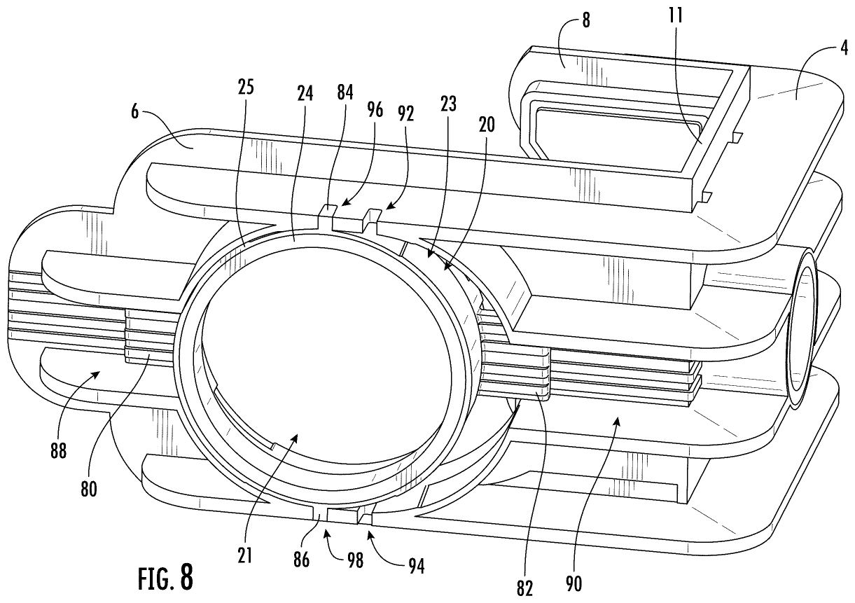

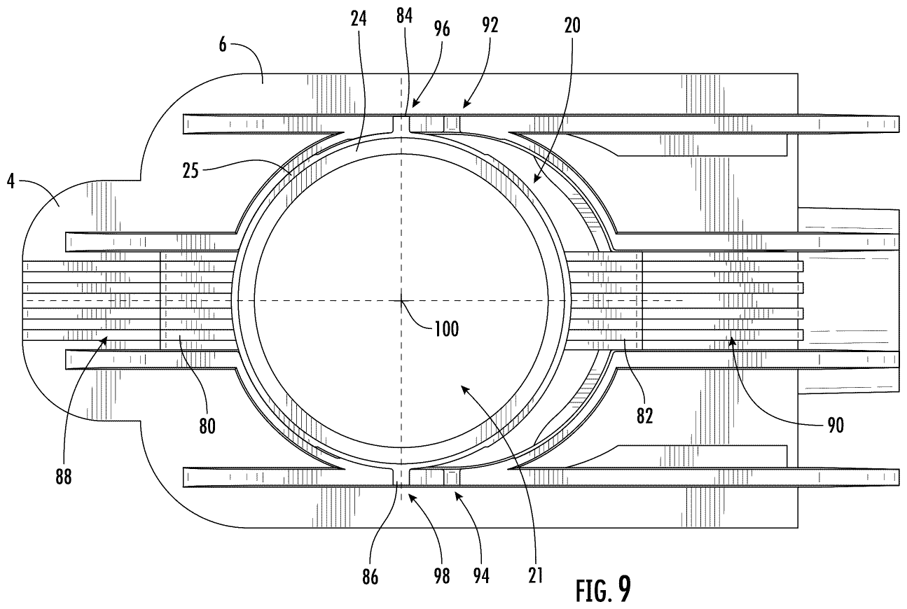

FIGS. 6 and 7 illustrate the jig 2 in a first configuration with the guide insert 23 in a first position relative to first leg 6 for forming the door handle borehole closer to the edge 11 of the door panel 3 and FIGS. 8 and 9 illustrate the jig 2 in a second configuration with the guide insert 23 in a second position relative to the first leg 6 for forming the door handle borehole further from the edge 11.

The first leg 6 includes a guide insert receiving aperture 20 for receiving a door latch hole saw guide insert 23.

The door latch hole saw guide insert 23 of this example is formed from multiple components including a metal sleeve 24 and a plastic carrier 25. In one example, the plastic carrier 25 is molded around sleeve 24 to form guide insert 23. The metal sleeve 24 is configured to mate with the outer periphery of the first hole saw 30 to guide and support the first hole saw 30 during drilling operations.

The plastic carrier 25 is configured to removably mount the guide insert 23 to the first leg 6 and particularly within the guide insert receiving aperture 20 in the first and second positions.

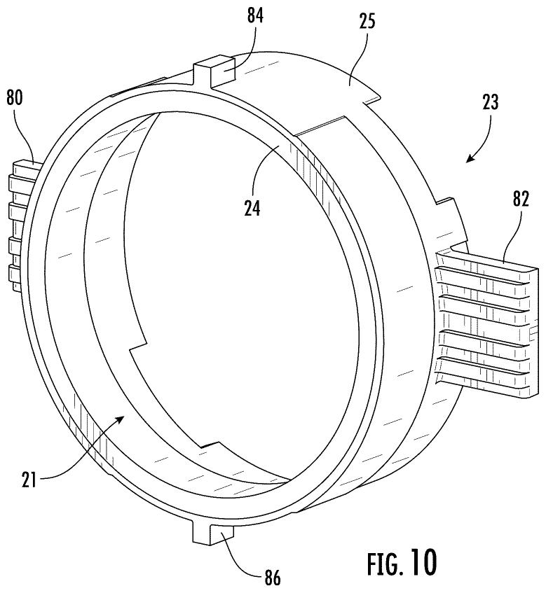

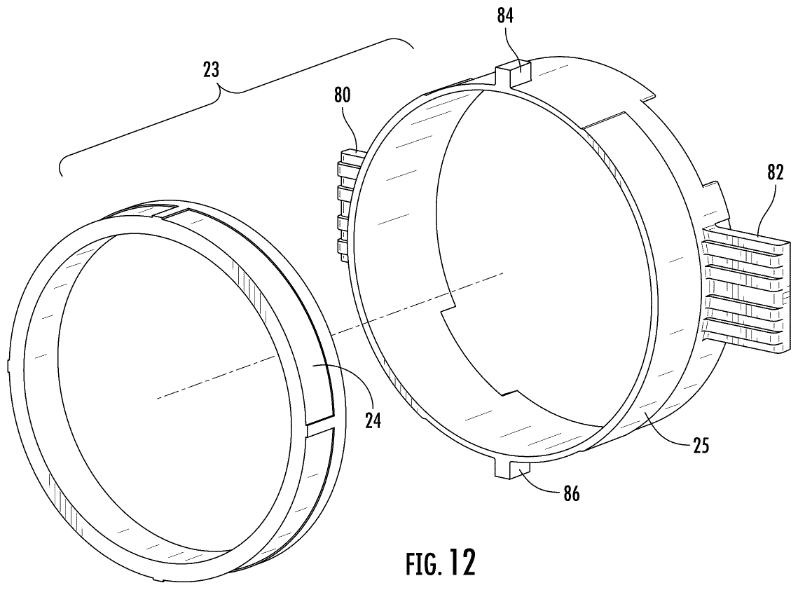

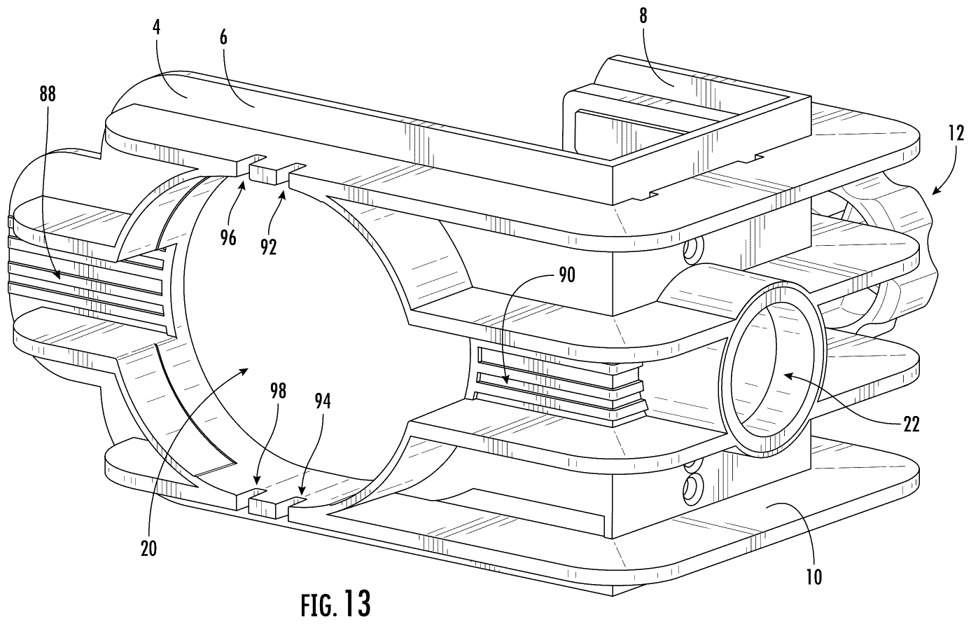

FIGS. 10-12 illustrate the guide insert 23 removed from the frame 4 and FIG. 13 illustrates the frame 4 without the guide insert 23.

To locate the guide insert 23 in the first position (FIGS. 6 and 7) and alternatively in the second position (FIGS. 8 and 9), the guide insert 23 includes a plurality of alignment tabs while the frame 4 and particular first leg 6 includes a plurality of alignment slots that cooperate with one another as will be described in more detail.

In particular, the guide insert 23 includes first and second first alignment tabs 80, 82 and first and second second alignment tabs 84, 86. The first alignment tabs 80, 82 cooperate with and are insertable into first and second first alignment slots 88, 90. The second alignment tabs 84, 86 are selectively insertable into first and second second alignment slots 92, 94 or first and second third alignment slots 96, 98 to locate the guide insert 23 in the first and second positions, respectively.

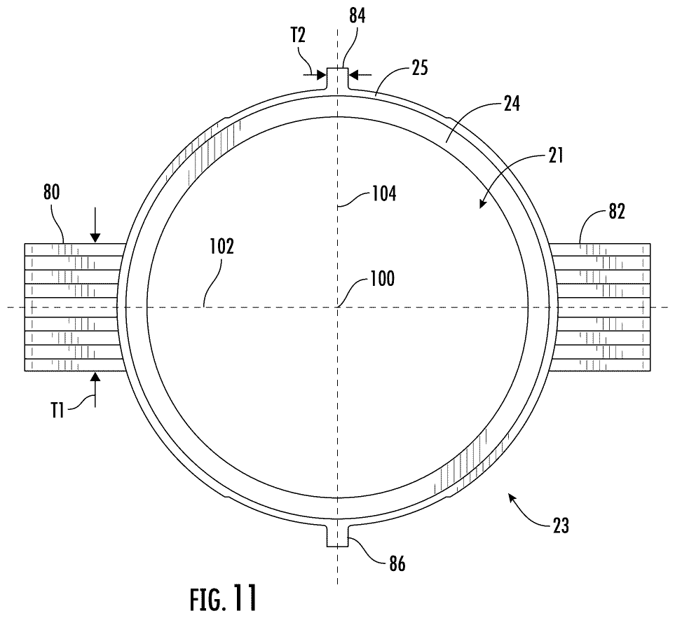

With reference to FIG. 11, the first and second first alignment tabs 80, 82 are aligned with one another on opposite sides of a guide aperture center 100 of the guide aperture 21. Similarly, first and second second alignment tabs 84, 86 are aligned with one another on opposite sides of the guide aperture center 100 of the guide aperture 21. In this example, the centerlines of the first alignment tabs 80, 82 are angularly offset about guide aperture center 100 by 90 degrees from the centerlines of the second alignment tabs 84, 86.

The first alignment tabs 80, 82 define a first axis 102 while the second alignment tabs 84, 86 define a second axis 104. The first and second axes 102, 104 are perpendicular to one another and intersect at center 100.

In this example, the guide insert 23 is 180 degrees rotation symmetric about center 100.

In this example, the first alignment tabs 80, 82 are generally larger than the second alignment tabs 84, 86. The first alignment tabs 80, 82 have a thickness T1 measured perpendicular to axis 102 and parallel to axis 104 that is greater than thickness T2 of the second alignment tabs 84, 86.

The first and second first alignment slots 88, 90 are aligned with one another and positioned on opposite sides of guide insert receiving aperture 20 and define axis 106. First and second second alignment slots 92, 94 are aligned with one another and positioned on opposite sides of guide insert receiving aperture 20 and define axis 108. First and second third alignment slots 96, 98 are aligned with one another and positioned on opposite sides of guide insert receiving aperture 20 and define axis 110.

In this example, the width W1 of the first alignment slots 88, 90 is substantially equal to thickness T1. The width W2 of the second alignment slots 92, 94 is substantially equal to the thickness T2 and the width W3 of the third alignment slots 96, 98. Width W1 is thus greater than widths W2 and W3. In this configuration, first alignment tabs 80, 82 are sized such that they cannot be received in second alignment slots 92, 94 or third alignment slots 96, 98. As such, the only way for insert to be mounted to first leg 6 is for the second alignment tabs 84, 86 to be aligned with and inserted into either the second alignment slots 92, 94 or the third alignment slots 96, 98.

In this example, but not required by all embodiments, in both the first position wherein the second alignment tabs 84, 86 engage the first alignment slots 92, 94 and the second position wherein the second alignment tabs 84, 86 engage the third alignment slots 96, 98 the first alignment tabs 80, 82 are engaged with the first alignment slots 88, 90. This is illustrated in FIGS. 6-9.

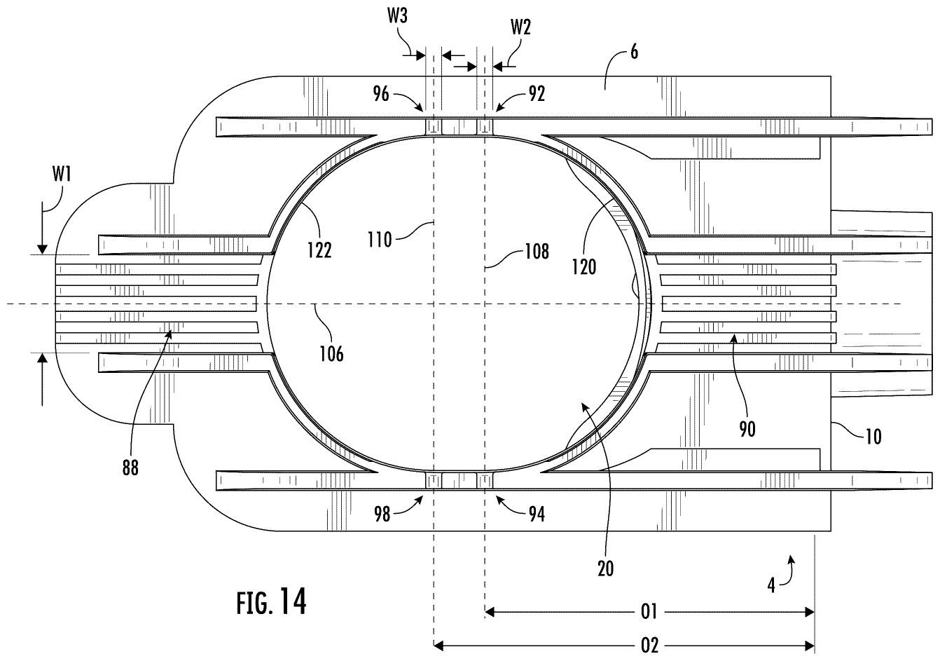

FIG. 14 illustrates the difference in offset between the first and second positions relative to the intermediate portion 10. Offset O1 illustrates the backset with the guide insert 23 located in the first position and the offset O2 illustrates the backset with the guide insert 23 located in the second position.

The guide insert receiving aperture 20, in this example is generally oblong along axis 106. When mounted in the first position, one side of the guide insert 23 is mated in one semi-circular portion 120 of the wall defining the guide insert receiving aperture 20. When mounted in the second position, the other side of the guide insert 23 is mated in the other semi-circular portion 122 of the wall defining the guide insert receiving aperture 20.

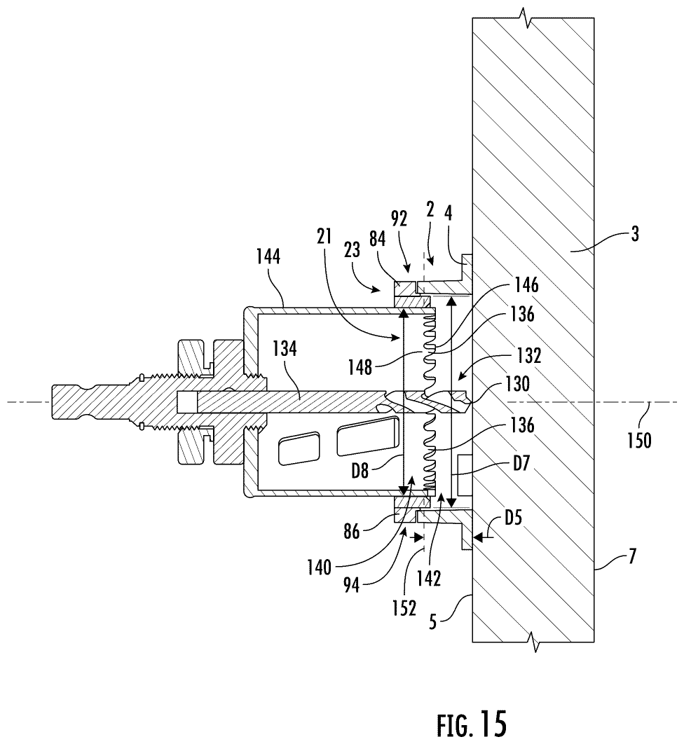

FIG. 15 illustrates the jig 2 mounted to a door panel 3 with first hole saw 30 inserted into guide insert receiving aperture 20. Here, the hole saw 30 has been inserted sufficiently far that a tip 130 of an exposed portion 132 of a guide bit 134 abuts the first side 5 of the door panel 3.

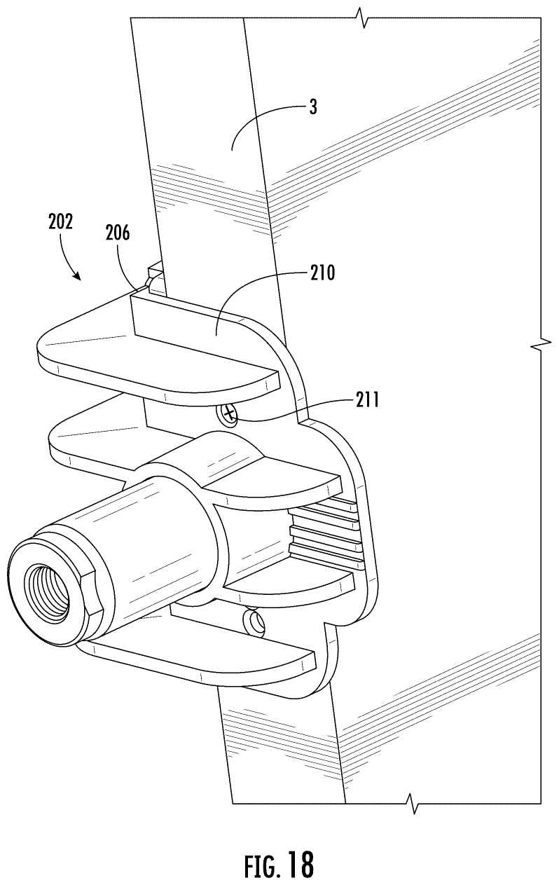

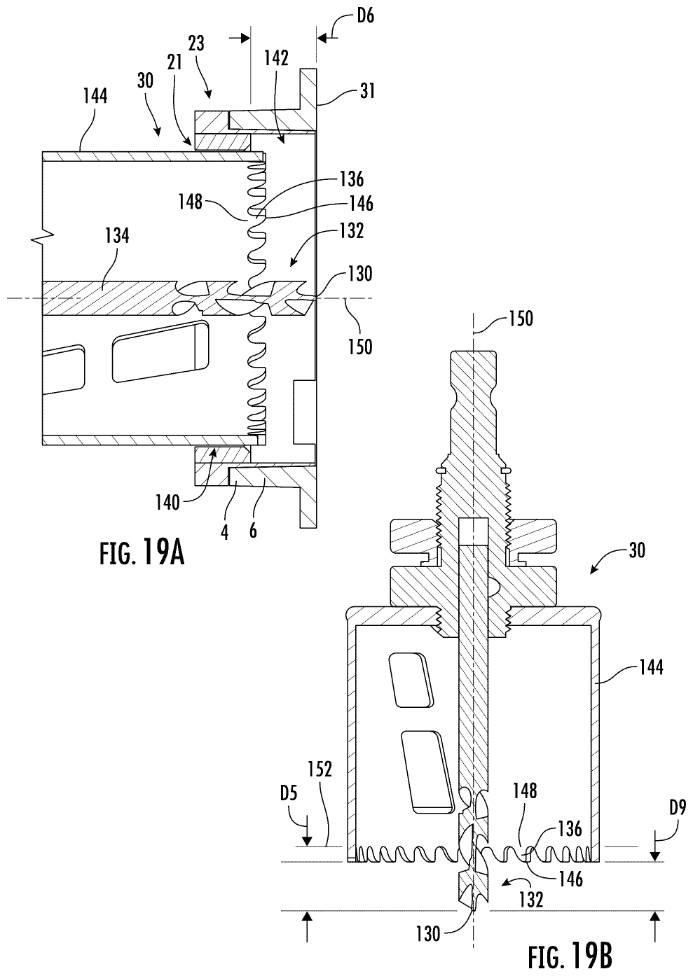

With additional reference to FIGS. 19A and 19B, the jig 2 is configured such that the teeth 136 of the hole saw 30 will not engage the guide insert 23 when fully inserted into the guide aperture 21 as illustrated. This allows the user to avoid damaging the guide insert 23 with the teeth 136 of the hole saw 30 or the inner surfaces of the guide insert 23. This is particularly true with hole saws that have set or an outward directed flare.

In particular, the user would fully insert the hole saw 30 into the guide insert 23 until it abuts side 5 (see FIG. 15) before activating a connected drill (not shown) or otherwise rotating the hole saw 30. In this position, the teeth 136 have fully cleared a guide region 140 of the guide insert 23 and have been inserted into a teeth clearance region 142.

Here, the teeth 136 are located at an end of a cylindrical body 144 of the hole saw 30. The guide bit 134 is centrally located in the cylindrical body 144 with the exposed portion 132 thereof extending axially outward beyond the tips 146 of the teeth 136 along central axis 150. Each tooth extends from the cylindrical body from a tooth root 148 to the tip 146.

The tip 130 of the expose portion 132 of the guide bit 134 is spaced apart from the roots 148 of the teeth 136 a distance D5 measured along the hole saw central axis 150 and perpendicular to a plane 152 defined by the roots 148 of the teeth 136.

The teeth clearance region 142 has depth D6 measured parallel to central axis 150 that is equal to or greater than distance D5. This depth is measured from the abutment surface 31 of first leg 6.

In some embodiments, the depth D6 of the teeth clearance region 142 is at least greater than or equal to the distance D9 between the tip 130 of the guide bit 134 and the plane defined by the tips 146 of the teeth 136. However, the embodiment where depth D6 is greater than distance D5 is preferred.

The teeth clearance region 142 is bound by a radially inward facing surface having diameter D7 that is greater than the diameter D8 of the radially inward facing surface bounding the hole saw guide region 140.

Notably, when spacer 29 is mounted to first leg 6, the effective depth of the teeth clearance region 142 is greater than when it is removed as the added thickness of the spacer 29 increases the clear space in which the teeth 136 may be received prior to activation of the drill or rotation of the hole saw 30.

This clearance arrangement can also be applied to the guide arrangement for guiding second hole saw 33 for forming the latch boreholes.

In this example, the teeth clearance region 142 is positioned axially between surface 31 and the hole saw guide region 140. A radial step is formed between the teeth clearance region 142 and the hole saw guide region 140. In a preferred example, the radially inward facing surface bounding the teeth clearance region 142 is formed from plastic.

In one example, this surface has angle of no more than 10 degrees and preferably less than 8 and even more preferably less than 5 degrees relative to the central axis passing through the hole saw guide aperture 21.

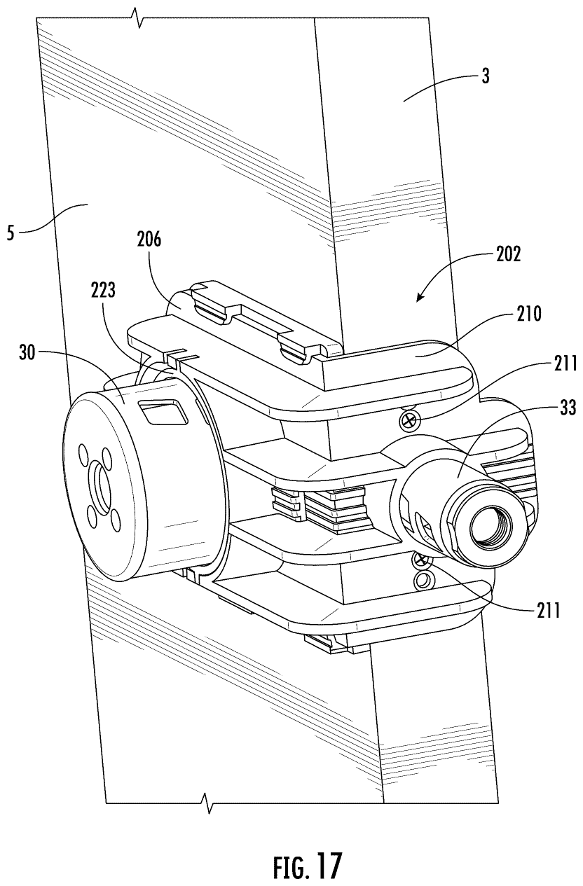

FIGS. 17 and 18 illustrate an alternative embodiment of a jig 202. In this embodiment, the jig 202 fails to include a clamp as in the prior embodiment. Here, the frame 204 is generally L shaped and includes first leg 206 and portion 210. Portion 210 is similar to intermediate portion 10 as it abuts the edge 11 of the door panel 3. However, in this example, it does not connect opposed leg portions of the frame.

In this example, the jig 202 is mechanically secured to the edge 11 of door panel 3 such as by way of screws 211 or nails. Screws are preferred as they are easier to remove when removing the jig 202 after the boreholes have been formed.

In this example, the entirety of the hole saw guide insert 223 is formed from plastic. However, the insert 223 is otherwise substantially similar to insert 23.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A backset jig for guiding a hole saw for forming holes in a door panel having first and second sides and an edge extending between the first and second sides for installation of a door lock comprising:
a frame including a first leg to be positioned adjacent the first side of the door panel in which a lock hole is to be formed, the frame having a first alignment tab slot, a second alignment tab slot, and a third alignment tab slot;
an abutment for abutting the edge of the door panel;
a hole saw guide insert having a hole saw guide aperture defining a guide aperture center, the hole saw guide insert having a first alignment tab and a second alignment tab, the second alignment tab angularly spaced from the first alignment tab by 90 degrees about the guide aperture center, the hole saw guide insert mountable to the first leg in a first position with the second alignment tab inserted into the second alignment tab slot positioning the guide aperture center a first distance from the abutment and in a second position with the second alignment tab inserted into the third alignment tab slot positioning the guide aperture center a second distance from the abutment.

2. The backset jig of claim 1, wherein the first alignment tab is inserted into the first alignment tab slot in both the first and second positions.

3. The backset jig of claim 1, wherein the first alignment tab can not be inserted into the second and third alignment tab slots or the second alignment tab cannot be inserted into the first alignment tab slot.

4. The backset jig of claim 1, wherein:
the first alignment tab has a first width and the first alignment tab slot has a second width substantially equal to the first width;
the second alignment tab has a third width and the second and third alignment tab slots have a fourth width substantially equal to the third width; and
wherein the first width is greater than the fourth width such that the first alignment tab cannot be received in the second or third alignment tab slots or the third width is greater than the second width such that the second alignment tab cannot be received in the first alignment tab slot.

5. The backset jig of claim 1, wherein the hole saw guide insert is 180 degrees rotation symmetric about the guide aperture center.

6. The backset jig of claim 1, wherein:
the first alignment tab is part of a first set of first alignment tabs having two first alignment tabs being positioned on opposite sides of the guide aperture center;
the first alignment slot is part of a first set of first alignment slots having two alignment slots; and
the first set of first alignment tabs are inserted into the first set of first alignment slots when the hole saw guide insert is mounted in the first and second positions.

7. The backset jig of claim 1, wherein:
the second alignment tab is part of a second set of second alignment tabs having two second alignment tabs being positioned on opposite sides of the guide aperture center;
the second alignment slot is part of a second set of second alignment slots having two second alignment slots;
the third alignment slot is part of a third set of third alignment slots having two third alignment slots;
the second set of alignment tabs are inserted into the second set of alignment slots when in the first position; and
the second set of alignment tabs are inserted into the third set of alignment slots when in the second position.

8. The backset jig of claim 6, wherein:
the second alignment tab is part of a second set of second alignment tabs having two second alignment tabs being positioned on opposite sides of the guide aperture center;
the second alignment slot is part of a second set of second alignment slots having two second alignment slots;
the third alignment slot is part of a third set of third alignment slots having two third alignment slots;
the second set of alignment tabs are inserted into the second set of alignment slots when in the first position; and
the second set of alignment tabs are inserted into the third set of alignment slots when in the second position.

9. The backset jig of claim 1, wherein the first leg has an insert receiving aperture in which the hole saw guide insert is mounted in both the first and second positions.

10. The backset jig of claim 8, wherein:
the first alignment slots of the first set of first alignment slots are on opposed sides of the insert receiving aperture and defining a first axis therebetween;
the second alignment slots of the second set of second alignment slots are on opposed sides of the insert receiving aperture and defining a second axis therebetween that is perpendicular to the first axis; and
the third alignment slots of the third set of third alignment slots are on opposed sides of the insert receiving aperture and defining a third axis therebetween that is perpendicular to the first axis and parallel to the second axis.

11. A backset jig kit for guiding a hole saw for forming holes in a door panel having first and second sides and an edge extending between the first and second sides for installation of a door lock comprising:
a hole saw having a cylindrical body having teeth at an end thereof and a central guide bit positioned radially inward of the teeth, each tooth extending axially from a root to a tooth tip, the central guide bit defining a hole saw central axis, the central guide bit having an exposed portion extending axially outward from the cylindrical body along the hole saw central axis, the expose portion of the guide bit having a distal end being spaced apart from the roots of the teeth a first distance measured along the hole saw central axis and perpendicular to a plane defined by the roots of the teeth;
a frame including a first leg having an abutment surface to be positioned against the first side of the door panel in which a lock hole is to be formed; and
a hole saw guide insert having a hole saw guide aperture, the hole saw guide aperture having a hole saw teeth clearance region having a first diameter and a hole saw guide region having a second diameter smaller than the first diameter, the hole saw teeth clearance region being positioned between the hole saw guide region and the abutment surface when the hole saw guide insert is mounted to the frame, the hole saw teeth clearance region having a depth measured from the abutment surface being equal to or greater than the first distance such that the teeth of the hole saw are fully received in the hole saw teeth clearance region when the tip of the central guide bit is aligned with the abutment surface.

12. The backset jig kit of claim 11, wherein the hole saw teeth clearance region has a radially inwardly facing surface that radially faces the hole saw central axis and which defines the first diameter, wherein the radially inwardly facing surface is substantially cylindrical and has a taper relative to the hole saw central axis of no more than 8 degrees.

13. The backset jig kit of claim 11, wherein a radial step is formed between the hole saw guide region and the hole saw teeth clearance region.

14. The backset jig kit of claim 11, wherein the hole saw guide region is provided by a metal component and the hole saw teeth clearance region is provided by a plastic component attached to the metal component.

15. The backset jig kit of claim 11, wherein the hole saw guide region is sized to receive the teeth of the hole saw axially therethrough.

16. The backset jig of claim 11, wherein:
the frame is an assembly including a spacer removably attachable to the first leg, the spacer providing the abutment surface when mounted to the leg;
the depth being greater than the first distance independent of the spacer.
